(19) United States
(12) Patent Application Publication
(10) Pub. No.: US 2026/0341043 A1
(43) Pub. Date: Oct. 29, 2026

(54) METHOD FOR DETECTING OBSTACLES ON UNEVEN GROUND

(71) Applicant: ZF Friedrichshafen AG, Friedrichshafen (DE)

(72) Inventors: Andreas Heinzler, Ravensburg (DE); Stefan Traub, Friedrichshafen (DE)

(73) Assignee: ZF Friedrichshafen AG, Friedrichshafen (DE)

(21) Appl. No.: 19/103,994

(22) PCT Filed: Jul. 21, 2023
(86) PCT No.: PCT/EP2023/070280

§ 371 Date: Feb. 14, 2025

(30) Foreign Application Priority Data
Aug. 22, 2022 (DE) 10 2022 208 646.5

(51) Int. Cl. G06V 20/56; G06V 20/58

(52) U.S. Cl. CPC G06V 20/588; G06V 20/58

(57) ABSTRACT

A method for detecting obstacles includes scanning a route ahead of a vehicle by means of a sensor, where the sensor data obtained are processed by a computer unit. An expected ground level is determined with reference to the vehicle geometry. An upper offset and a lower offset relative to the expected ground level are specified, where a range is defined by the upper and lower offsets. Sensor data received are filtered out if they are within the range defined. When a signature is received which is outside the defined range, then at least the upper offset is changed in such manner that the defined range is adapted around the signature received.

### RELATED APPLICATIONS

This application claims the benefit under 35 U.S.C. § 371 as a U.S. National Phase Application of application no. PCT/EP2023/070280, filed on 21 Jul. 2023, which claims the benefit of German Patent Application no. 10 2022 208 646.5 filed on 22 Aug. 2022, the contents of which are hereby incorporated herein by reference in their entireties.

### FIELD OF THE DISCLOSURE

The present invention relates to a method for detecting obstacles in a vehicle, an obstacle being understood to be an object which the vehicle concerned cannot drive over. In addition, a computer program product is included.

### BACKGROUND

From the prior art various methods for detecting obstacles are known. For example, DE 10 2013 200 385 A1 relates to a method for assisting the driver of a vehicle while travelling over uneven ground, a corresponding device and a corresponding computer program product. By means of optical, radar, or lidar sensors, a hump in the ground to be driven over is detected and classified in terms of whether the hump constitutes an obstacle that precludes undamaged continued driving of the vehicle. Besides an uphill or downhill gradient, the obstacle or unevenness may be a pothole, a ramp, or a transverse or longitudinal furrow.

Furthermore DE 10 2012 203 091 A1 discloses methods for the detection of objects in the surroundings of a motor vehicle, by means of a distance sensor that works by the pulse-echo method. The method makes it possible, if the ground is not very reflective, to lower a threshold specified by a characteristic curve and thereby to increase the sensitivity. In that way even weakly reflective objects can be detected. Furthermore, the method makes it possible, particularly if due to highly reflective ground strong interfering signals occur, to fade these out by raising the threshold specified by the characteristic curve. This enables the signals to be unambiguously associated with objects without false positives due to ground signal measurements. Moreover, by virtue of the method according to the invention not only are ground signals disregarded but it is also possible to fade out interfering signals produced, for example, by faulty measurements.

### SUMMARY

The purpose of the present invention is to provide an improved method for obstacle detection, especially when the vehicle is operated on uneven ground.

That objective is achieved by the method according to the invention for detecting obstacles. In this case a route ahead of the vehicle is scanned by a sensor. The sensor data so obtained are processed by a computer unit, and in a first step an expected ground level is determined.

The vehicle can be a vehicle of any type, but in particular an off-road vehicle. At times the vehicle may be one that is operated conventionally by an operator, or a partially automated vehicle or a fully automatic vehicle. In particular the vehicle can be a working machine, such as an agricultural, forestry, or building machine. These types are typically operated doing work on uneven ground or on an uneven route. In particular the route is a road, a cross-country route, a building site, or a usable agricultural area-in other words unpaved ground. In such cases the route often includes uneven topography. This can be because of unpaved or un-flattened ground, with ruts, potholes, furrows, curb stones, mounds, or rubble. The sensor is one that can deliver depth information, such as a (3D)-lidar, a (3D)-radar, a ToF camera, or a stereo-camera. The sensor types can also be combined with one another to improve object recognition. Depending on the type of sensor, the sensor is a transmitter/receiver unit, since particularly in the case of a radar or lidar sensor a signal is emitted and a reflected signal is received. The computer unit can be a separate computer unit, or it can sometimes be integrated into some other equipment. In particular the computer unit can be integrated in the sensor or the transmitter/receiver unit. Alternatively, the computer unit can be imbedded in another control unit of the vehicle.

The determination of the expected ground level describes the determination of a level or area in which an expected route lies and is done, for example, with reference to an extrapolation of the route just or most recently travelled over, having regard to the geometry of the vehicle, to a vehicle orientation, and with reference to position data and/or map data. In particular, acceleration sensors and/or inclination sensors may be involved in the determination of the expected ground level. Furthermore, short-term effects caused by travelling over uneven ground can be compensated or eliminated by means of the acceleration and inclination sensors when determining the expected ground level. Inasmuch as knowledge about uphill and downhill gradients can be provided by position and/or map data, that information can be taken into account for the determination of the expected ground level. Sometimes, in this case a data interface can be provided by way of which data exchange takes place with a server or with a remote control system in order to obtain corresponding topographical or map data and take it into account.

In a second step of the method, an upper offset and a lower offset relative to the expected ground level are specified, the upper and lower offsets delimiting a range. The upper and lower offsets can be of the same size, i.e., their values may be equal. In other words, the upper and lower offsets constitute boundaries which define or limit the range. For example, the length of the range formed can coincide with the distal end of the detection range of the sensors, i.e., with the distal length of the expected ground level and the upper or lower offset. For spatial assignment a positive sign can be associated with the upper offset and a negative sign with the lower offset. In that case positive and negative signs refer to the orientation relative to the expected ground level. Considered from the side, the range appears as a surface, but in reality a volume in the space ahead of the vehicle is described. That is because the range covered by the sensors ahead of the vehicle also has a lateral dimension.

In a third step, sensor data obtained are filtered out if they are within the range defined. Thus, on the one hand uncritical data can be ignored, so that the data to be processed can be substantially reduced. Consequently, less computer power is used for the processing of non-essential data. Alternatively, the scanning range of the sensors can also be restricted in such manner that scanning takes place exclusively outside the defined range.

If a signature outside the defined range is detected, in a fourth step at least the upper offset is changed in such manner that the signature received is adapted to around the defined range. A signature describes a signal characteristic which is caused by an object, in particular an obstacle. Consequently, such a signature can be produced by a reflected signal (e.g., radar, lidar) or by image recognition if an imaging sensor (e.g., a camera) is used. The offset can be changed either by adapting the value of the offset for the whole of range defined, or distally limited to the immediate distal vicinity of the object. The offset can also be adapted in the form of an adaptation curve. In this, a reduction of the offset is particularly advantageous. The adaptation described takes place mainly in relation to the upper offset, but it is possible to adapt both the upper and the lower offset. The two offsets can be adapted symmetrically relative to the expected ground level, or the upper and lower offsets can be adapted individually. The offset can even be deactivated temporarily.

In a further development of the method, in a fifth step a signal can be emitted by the computer unit in response to the signature. The signal emitted can be a notification sent to a man-machine interface, for example in the form of a display. Alternatively, or in addition, drive-dynamical parameters of the vehicle can be adapted, for example a driving speed. Furthermore, operating parameters of the motor (torque, rotation speed, power), or of the transmission (gearshift), or of differential locks (locking/unlocking) can be adapted. Moreover, a vehicle can be brought to rest, or an emergency stop can be initiated by the signal from the computer unit.

When a signature has been received, further sensors can mainly scan the adapted range defined in which the signature was obtained. In that way, in particular an assessment or confirmation of the signature received can take place with reference to the various sensor data.

In a further development, as a maximum value at least for the upper offset a value can be specified which corresponds to a maximum acceptable obstacle height. This means that the vehicle can drive over obstacles lower than the maximum acceptable obstacle height, whereas attempting to drive over an obstacle higher than the acceptable maximum would result in a collision and hence damage to the vehicle. Too steep an uphill gradient could also be regarded as an obstacle higher than an acceptable maximum. Both the upper and the lower offset can be specified by an operator or by way of the data interface. The offset values can also be stored in a storage element of the vehicle.

Alternatively, or in addition, the upper and/or the lower offsets are variable over a certain distance. This means that close to the vehicle a different offset can be specified than at a larger distance. In that way distant objects can be recognized early on, whereas a precise detection takes place nearer to the vehicle.

Furthermore, the upper and/or lower offsets can be varied as a function of a current vehicle speed or a speed specification. This means that sometimes at higher speeds smaller objects can be more difficult to drive over, whereas at a lower speed they could be passed over sometimes without any problem. It may also be necessary, at a higher vehicle speed, to recognize objects early on and sometimes while approaching them to carry out precise processing of the sensor data or the signatures received. Just as in the case of an actual vehicle speed, the above-described procedure should also be applied to a speed specification. In that respect a current actual vehicle speed differs from a driving instruction in that now and then, owing to external influences (insufficient motor power, traction, starting process) an actual vehicle speed will deviate from a speed specification.

As a further development, topographical data from other data sources can be sent to the computer unit and combined with the sensor data received. This means, for example, that topographical data can be used to check the plausibility of the sensor data received.

According to a further aspect of the present invention, the invention relates to a computer program product containing commands which, when the program is run on a computer, enable it to carry out the method according to the invention. The computer can for example be the aforesaid computer unit. Alternatively, the computer or computer unit can be integrated in the sensor or in the transmitter/receiver unit. Furthermore, the computer program product can be implemented on a Smartphone, a Tablet-PC, or carried out remotely by way of a calculator. The computer program product can also be implemented on any other control unit of the vehicle, for example a transmission control unit or a motor control unit or on a vehicle guidance computer.

The machine learning method can also be used to optimize the object recognition and/or the adaptation of the offsets.

### BRIEF DESCRIPTION OF THE DRAWING

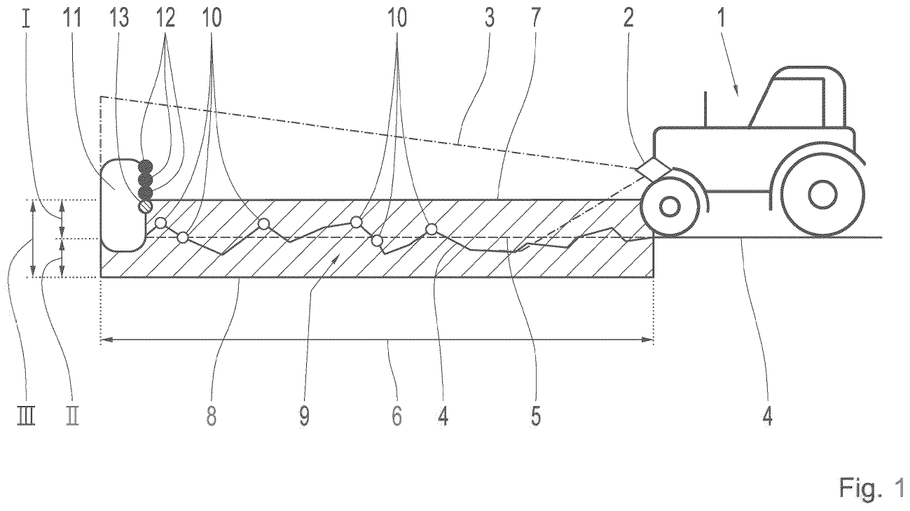

Below, the invention will be described with reference to the sole FIG. 1, which shows a vehicle in the form of an agricultural machine, in accordance with an embodiment of the present disclosure.

### DETAILED DESCRIPTION

The sole FIGURE shows a vehicle 1 in the form of an agricultural machine. On the front of the vehicle 1 there is a sensor 2. The sensor 2 has a scanning range 3 directed ahead of it, which is represented by dash-dot lines. The vehicle I is driving along a route 4 represented by continuous straight lines.

Starting from the current route 4, an expected ground level 5 is determined, which in the present case is a continuation of the current route 4 denoted by a broken line. In an anticipated section 6 the route 4 has an uneven topography characterized by humps and depressions. The anticipated section 6 lies ahead of the vehicle 1 and its extension corresponds to the distal length of the scanning range 3.

An upper offset 7 and a lower offset 8 define a range 9 around the expected ground level 5, which range is shown by the shading. Thus, in the side-view shown here the upper and lower offsets 7, 8 delimit a surface around the expected ground level 5. A perspective view would show that in contrast, the range 9 is not a surface but a volume which can be described by the expected ground level 5 and the upper and lower offsets 7, 8. In this case the upper offset I and the lower offset II are of equal size, so that the range 9 defined is symmetrical about the expected ground level 5. Consequently, a height III of the range defined corresponds to the sum of the upper and lower offsets I and II, and can be described by the equation (II=I+II).

On the other hand, as soon as an object 11 projects out of the range 9 defined, the sensor data are detected and a signature of the object 11 is received. In this case the sensor data taken into account are represented as solidly filled circles. Consequently, an object 11 has been detected which constitutes an obstacle for the vehicle 1, i.e., which can sometimes not be driven over. For the further assessment of the sensor data, in an area around the object 11 or around the sensor data 12 taken into account, the upper and lower offsets 7, 8 can now be adapted in order to obtain a more accurate picture of the object 11. In this case, the upper offset 7 has been reduced so that lower-lying signatures too are taken into account. These enhanced sensor data 13 are represented by a shaded circle. As an example, only one further point is added in FIG. 1. Depending on the method, however, the offsets 7, 8 can be adapted further until a complete signature of the object Il has been obtained and the object 11 is thereby classified.

The result is that by virtue of the sensor data 12, 13 obtained a signal is emitted to the effect that there is an obstacle ahead of the vehicle 1 which cannot be driven over. Consequently, a warning signal could be emitted, a stopping process initiated, or an alternative trajectory determined in order to steer round the obstacle.

No computer unit is shown in FIG. 1, but this does not mean that one such is not included in the invention. For example, the computer unit can be integrated in the sensor 2. Moreover, no further sensors of the type mentioned earlier are shown. These can also be integrated as a unit in the sensor 2 or provided in or on the vehicle I at suitable locations. By means of the further sensors, in particular the adapted range 9 or the signatures of the object Il obtained can be taken into account.

### INDEXES

1 Vehicle
2 Sensor
3 Scanning range
4 Route
5 Expected ground level
6 Anticipated section
7 Upper offset
8 Lower offset
9 Defined range
10 Filtered-out sensor data
11 Object
12 Sensor data taken into account
13 Additional sensor data
I Offset value of the upper offset
II Offset value of the lower offset
III Height range

1. A method for detecting obstacles in a route ahead of a vehicle, the method comprising:
scanning, by a sensor, the route ahead of the vehicle to obtain sensor data;
processing the sensor data by a computer unit, wherein the processing includes:
determining an expected ground level;
specifying an upper offset (7) and a lower offset (8) relative to the expected ground level (5) such that the upper and lower offsets (7, 8) define a range (9);
determining that at least some of the sensor data (10) are within the range (9);
filtering out the at least some sensor data (10) within the range (9); and
receiving a signature that is outside the range (9) is received; and
changing at least the upper offset (7) in such manner that the range (9) is adapted to define an adapted range containing the signature.

2. The method according to claim 1, comprising emitting, by the computer unit, a signal in response to the signature.

3. The method according to claim 1, comprising detecting, by further sensors, the adapted range (9).

4. The method according to claim 1, comprising specifying a maximum value at least for the upper offset (7), the maximum value corresponding to a maximum acceptable obstacle height.

5. The method according to claim 1, wherein the upper and/or lower offset(s) (7, 8) is/are variable over a certain distance.

6. The method according to claim 1, wherein the upper and/or lower offset(s) (7, 8) is/are variable as a function of a current driving speed or of a speed specification.

7. The method according to claim 1, comprising:
sending topographical data from further data sources to the computer unit; and
combining the topographical data with the sensor data (10, 12, 13) received.

8. A non-transitory computer-readable recording medium carrying a computer program that performs the method of claim 1.
